(19) United States
(12) Patent Application Publication
(10) Pub. No.: US 2025/0310904 A1
(43) Pub. Date: Oct. 2, 2025

(54) ADJUSTING LATENCY IN AUDIO STREAMS

(71) Applicant: QUALCOMM Incorporated, San Diego, CA (US)

(72) Inventors: Megan Lucy TAGGART, Newtownabbey (GB); Richard TURNER, Belfast (GB); Derrick REA, Broughshane (GB); Laurent WOJCIESZAK, Belfast (GB)

(21) Appl. No.: 19/090,253

(22) Filed: Mar. 25, 2025

Related U.S. Application Data
(60) Provisional application No. 63/570,728, filed on Mar. 27, 2024.

(51) Int. Cl. H04W 56/00; G06F 3/16; G10L 19/005

(52) U.S. Cl. CPC H04W 56/001; G06F 3/162; G06F 3/165; G10L 19/005

(57) ABSTRACT

Various aspects of the present disclosure generally relate to wireless communication. In some aspects, an audio stream decoder may receive, from an audio stream encoder, an audio stream. The audio stream decoder may receive, from the audio stream encoder, latency control signaling to adjust latency for the audio stream using a combination of multiple time modification algorithms. The audio stream decoder may adjust, based at least in part on the latency control signaling, the latency using the combination of multiple time modification algorithms. Numerous other aspects are described.

### CROSS-REFERENCE TO RELATED APPLICATION

This Patent Application claims priority to U.S. Provisional Patent Application No. 63/570,728, filed on Mar. 27, 2024, entitled “ADJUSTING LATENCY IN AUDIO STREAMS,” and assigned to the assignee hereof. The disclosure of the prior Application is considered part of and is incorporated by reference into this Patent Application.

### TECHNICAL FIELD

This disclosure relates generally to wireless communication, and more specifically, to techniques, apparatuses, and methods for adjusting latency in audio streams.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

The WLAN may support audio streaming from the one or more wireless APs to one or more client devices. An audio stream may be associated with latency. Latency may be a time delay between an audio source and playback. Different levels of latency may be acceptable for different applications. For example, relatively high latency may be acceptable for music streaming, medium latency may be desirable for video calls, and/or relatively low latency may be desirable for live performance and real-time audio. Factors affecting latency in audio streaming may include a network configuration, audio compression, and/or audio buffering. Latency may be adjusted to improve a quality (e.g., reduced latency) associated with the audio streaming.

### SUMMARY

The systems, methods and devices of this disclosure each have several innovative aspects, no single one of which is solely responsible for the desirable attributes disclosed herein.

One innovative aspect of the subject matter described in this disclosure can be implemented in an audio device. The audio stream decoder includes one or more memories; and one or more processors, coupled to the one or more memories, configured to cause the audio device to: receive, from an audio stream encoder, an audio stream; receive, from the audio stream encoder and prior to a switching event, latency control signaling to maintain synchronization between different audio channels associated with the audio device and to adjust latency for the audio stream using a combination of multiple time modification algorithms; and adjust, based at least in part on the latency control signaling and prior to the switching event, the latency using the combination of multiple time modification algorithms.

One innovative aspect of the subject matter described in this disclosure can be implemented in a mobile station (STA). The STA includes one or more memories; and one or more processors, coupled to the one or more memories, configured to cause the STA to: transmit, to an audio stream decoder and prior to a switching event, an audio stream; and transmit, to the audio stream decoder, latency control signaling to maintain synchronization between different audio channels associated with the audio device and to adjust latency for the audio stream using a combination of multiple time modification algorithms.

Another innovative aspect of the subject matter described in this disclosure can be implemented in a method performed at an audio device. The method includes receiving, from an audio stream encoder, an audio stream; receiving, from the audio stream encoder and prior to a switching event, latency control signaling to maintain synchronization between different audio channels associated with the audio device and to adjust latency for the audio stream using a combination of multiple time modification algorithms; and adjusting, based at least in part on the latency control signaling and prior to the switching event, the latency using the combination of multiple time modification algorithms.

Another innovative aspect of the subject matter described in this disclosure can be implemented in a method performed at a STA. The method includes transmitting, to an audio stream decoder and prior to a switching event, an audio stream; and transmitting, to the audio stream decoder, latency control signaling to maintain synchronization between different audio channels associated with the audio device and to adjust latency for the audio stream using a combination of multiple time modification algorithms.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram of an example wireless communication network.

FIG. 2 is an example protocol data unit (PDU) usable for communications between a wireless access point and one or more wireless stations.

FIG. 3 is a diagram of an example of synchronization and control of multiple earbuds.

FIG. 4 is a diagram of an example of audio streaming between a UE and earbuds.

FIG. 5A is a diagram of an example of latency during an access point (AP) switch event.

FIG. 5B is a diagram of a fixed rate overlap add (FROLA) time modification algorithm.

FIG. 6 is a diagram of an example of signaling control bits to control and synchronize time modifications in two earbuds.

FIG. 7 is a diagram of an example of three control bits associated with increasing latency.

FIG. 8 is a diagram of an example of three control bits associated with decreasing latency.

FIG. 9 is a diagram of an example of audio decoding.

FIG. 10 is a diagram of an example of audio decoding.

FIG. 11 is a diagram of an example of audio decoding.

FIG. 12 is a diagram of an example of audio decoding.

FIG. 13 is a flowchart illustrating an example process performable by an audio device that supports adjusting latency in audio streams.

FIG. 14 is a flowchart illustrating an example process performable by a mobile station that supports adjusting latency in audio streams.

FIG. 15 is a flowchart illustrating an example process performable by an audio device that supports adjusting latency in audio streams.

FIG. 16 is a flowchart illustrating an example process performable by a mobile station that supports adjusting latency in audio streams.

FIG. 17 is a block diagram of an example wireless communication device that supports adjusting latency in audio streams.

FIG. 18 is a block diagram of an example wireless communication device that supports adjusting latency in audio streams.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In an extended personal area network (XPAN), a WLAN (e.g., Wi-Fi) may be used to transport WPAN audio data (e.g., Bluetooth audio data). In an XPAN, different contexts may be associated with different latency requirements. For example, when a user equipment (UE) is streaming audio via an access point (AP) and/or roaming between APs, a link latency between the UE and an audio device (e.g., headphones or earbuds) may need to be increased relatively quickly to handle a disruption to a network and to avoid glitches. As another example, in a gaming context, the UE may transmit/receive information associated with a gaming (low-latency) application, and then the UE may stop the gaming application and switch to a non-gaming (delay-tolerant) application associated with a Whole Home Coverage (WHC), which may have a different latency requirement than the gaming application. For example, the gaming application may have a lower latency requirement as compared to the non-gaming application. When switching from the gaming application to the non-gaming application, the link latency between the UE and the audio device may need to be increased relatively quickly to avoid performance degradation that may result from the different latency requirements. For example, when switching from a low latency context to a higher latency context, or vice versa, a latency associated with a data stream may be adjusted to minimize perceptible disruptions to a user of the UE (e.g., the latency may be increased when switching from a low latency use to a high latency use and decreased when switching from a high latency context to a low latency context). Although lower latency is generally preferred, there may be situations where a UE may switch to using a higher latency. Smoothing a transition between different latency requirements during such a switch may be needed so that latency changes are imperceptible to the user. For example, during latency changes, audio streams associated with different audio channels may become out-of-synchronization (e.g., a first audio stream associated with a first earbud of the audio device may become out-of-sync with a second earbud of the audio device), and this out-of-synchronization may be perceptible to the user. Therefore, during latency changes, a time alignment between the different audio channels may be needed to ensure synchronization (e.g., between the first earbud and the second earbud) and some techniques, such as a sample rate converter (SRC) (e.g., a polyphase filter), may not be sufficient, particularly at higher sampling rates (e.g., above 5 milliseconds per second (ms/second)), as they may still introduce perceptible audio issues (e.g., pitch change) when adjusting end-to-end latency.

Various aspects relate generally to adjusting latency in audio streams, such as when a UE moves between two APs, switches applications, or transitions between Wi-Fi and Bluetooth. For example, an audio stream decoder of an audio device (e.g., a pair of earbuds) may adjust an amount of latency to an audio stream that is received from an audio stream encoder (e.g., a UE) based on detecting a switching event (e.g., a change in latency or latency requirements preceding, or otherwise associated with, an AP or application switch). In some cases, the latency adjustment may be due to no change in wireless band (e.g., streaming over Bluetooth Low Energy at 30 milliseconds (ms) latency and switching to high quality at 200 ms latency). The audio stream decoder may adjust the amount of latency by employing a combination of time modification algorithms. For example, the audio stream decoder may apply a combination of a fixed rate overlap add (FROLA) time modification algorithm and a waveform similarity overlap add (WSOLA) time modification algorithm in order to adjust the latency in the audio stream. In some cases, FROLA and WSOLA may be run at either the audio stream decoder or the audio stream encoder. The audio stream decoder may use the FROLA time modification algorithm to build a buffer of un-played audio. The audio stream decoder may use the WSOLA time modification algorithm to stretch the audio stream in a time domain to add latency, but without a perceptible pitch change. The WSOLA time modification algorithm may stretch the audio stream using the buffer of un-played audio. Further, the audio stream encoder may compute timestamps for different audio channels of audio, such that the audio stream encoder is able to maintain synchronization (e.g., synchronization between two earbuds), and the audio stream encoder may signal the timestamps to the audio stream decoder. The WSOLA time modification algorithm and the FROLA time modification algorithm may be employed at the audio stream decoder while still maintaining the timestamps indicated by the audio stream encoder, thereby maintaining synchronization at the audio device. For example, some aspects may use signaling to maintain synchronization of timestamps between two earbuds connected to the UE.

Some aspects more specifically relate to an audio stream decoder that receives, from an audio stream encoder, an audio stream. The audio stream decoder may receive, from the audio stream encoder and prior to a switching event, latency control signaling to maintain synchronization between different audio channels associated with the audio device and to adjust latency for the audio stream using a combination of multiple time modification algorithms. The audio stream decoder may adjust, based at least in part on the latency control signaling and prior to the switching event, the latency using the combination of multiple time modification algorithms. In some aspects, the audio stream decoder may apply time modification to stretch audio in the audio stream, where the stretched audio may be associated with added latency. Alternatively, the audio stream decoder may apply the time modification to contract the audio in the audio stream, where the contracted audio may be associated with reduced latency. The audio stream decoder may adjust, based at least in part on the latency control signaling, the latency using the combination of the FROLA time modification algorithm and the WSOLA time modification algorithm. The audio stream decoder may build a buffer of un-played audio using the FROLA time modification algorithm. The audio stream decoder may select, from the buffer of un-played audio, a section of audio in the audio stream to repeat using the WSOLA time modification algorithm. A switch between the FROLA time modification algorithm and the WSOLA time modification algorithm may be associated with a latency adjustment.

In some aspects, the latency control signaling may include an indication of one or more timestamps at which the time modification is to be applied to the audio stream, where the latency control signaling may be to control and synchronize the time modification at the audio stream decoder. The latency control signaling may include one or more latency control words, where the audio stream decoder may perform a packet loss concealment for packet loss and time correction based at least in part on the one or more latency control words. In some aspects, timestamps may be utilized when the packet loss concealment or a use of the WSOLA time modification algorithm stops. In this case, any discrepancies between generated audio and the timestamps may be corrected or stretching or shrinking audio using the FROLA time modification algorithm. Timestamps in a header may be compared to generated audio and an error calculated may be used to achieve latency control. In some aspects, in order to achieve the latency adjustment, a combination of sample rate converter (SRC) and the WSOLA time modification algorithm may be used, or a combination of the FROLA time modification algorithm and an SRC may be used (e.g., SRC may add less distortion than FROLA, but is not zero latency, so FROLA may be used for buffering and then SRC may be used as needed).

In some aspects, the audio stream encoder may be associated with latency control logic and time synchronization, and the audio stream decoder may be associated with multiple time modification algorithms. The latency may be adjusted prior to a switch between APs. The audio stream encoder and the audio stream decoder may be associated with an XPAN. The audio stream decoder may be associated with a pair of earbuds.

Particular aspects of the subject matter described in this disclosure can be implemented to realize one or more of the following potential advantages. In some examples, by employing latency control signaling to adjust latency in the audio stream, the described techniques can be used to handle different latency requirements associated with different contexts. The latency control signaling may handle the different latency requirements when switching between the different contexts, which may be based at least in part on employing multiple time modification algorithms. For example, the latency adjustment may enable an interruption in the audio stream to be avoided during the switch between the APs. As another example, the latency adjustment may avoid a glitch when switching between a gaming application and a non-gaming application, or vice versa. Further, some aspects described herein may reduce or eliminate perceptible audio issues that may result from use of some end-to-end latency techniques at higher rates. For example, certain aspects may provide a latency adjustment that occurs without a pitch change in the audio stream, thereby making the latency adjustment imperceptible to a user associated with the audio device. In addition, the use of control signaling may reduce or eliminate out-of-synchronization audio among audio devices (e.g., a pair of earbuds) connected to the UE. Further, the audio stream decoder may handle complex buffer arrangements to achieve latency control. For example, the audio stream decoder may perform buffer management using a separate state machine driven control logic. Thus, employing the latency control signaling and the combination of multiple time modification algorithms (e.g., FROLA and WSOLA) for latency adjustment may improve an overall system performance.

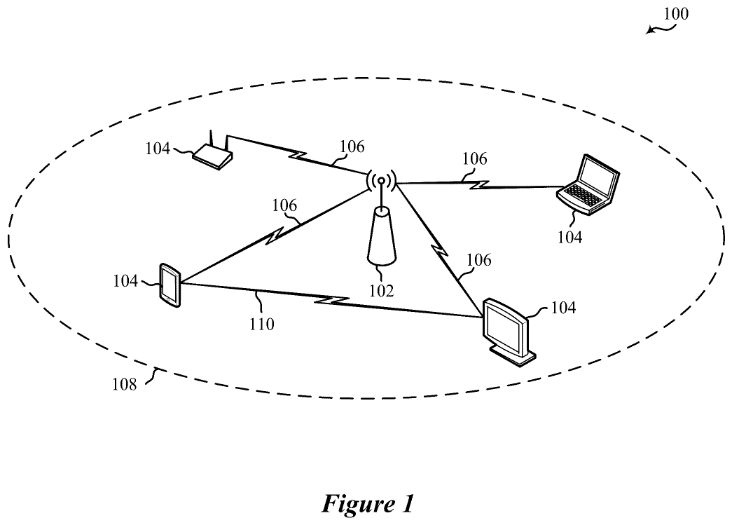

FIG. 1 is a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, or the like) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (us)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. Accordingly, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

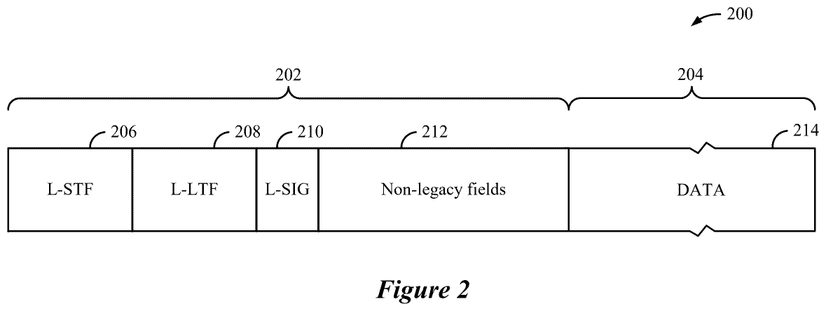

FIG. 2 is an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In an XPAN, when a UE is streaming audio via an AP or roaming between APs, a link latency may need to be increased relatively quickly to handle a disruption to a network and to avoid glitches, and the XPAN may need to support roaming between APs without interruptions in audio. Supporting roaming may require a WHC latency to increase relatively quickly while minimizing noticeable effects to a user of the UE. Depending on a Wi-Fi AP vendor, protocol implementations may vary, and time may be needed to switch between APs, where the switching may involve a key exchange, authentication, and other procedures. Furthermore, after switching APs, transport layer links may need to be reconnected (e.g., a transmission control protocol (TCP) reconnect may be performed due to an Internet Protocol (IP) address change). An amount of time to switch to an AP or between APs may be greater than 150 ms for each transport switch step, which may result in an audio codec buffering audio to maintain continuous streaming. In some cases, large gaps of silence in audio may be present when the transport steps occur, which would degrade an overall system experience.

An end-to-end latency should be minimized to achieve a best user experience. A high latency may cause button presses to feel unresponsive and/or may add a time lag to voice calls. Furthermore, XPAN voice calls may have latency-related key performance indicator (KPI) constraints that should be met for certification (e.g., round-trip latency and/or response times). A dynamically adjusted latency may provide the user with a best latency for link quality, which may involve adjusting the latency depending on a quality of a wireless link and keeping link latency low. Planned switches between bearers such as a switch between a Bluetooth Low Energy (BLE) bearer and a bearer supporting WHC may require the latency to be increased relatively fast.

Moving from low latency streaming (e.g., gaming or voice) to WHC latency may require an increase of latency of 500 ms. When transitioning from a game or application over BLE to Wi-Fi, the latency change needed is relatively large. Gaming latency may be relatively low (e.g., less than 60 ms latency), whereas a WHC latency is typically relatively high (e.g., in the order of 500 ms). Low latency audio streams, such as gaming, may have minimal buffering. A latency change should be imperceptible to the user and relatively fast (e.g., less than 2 seconds). A time to transition from low latency streaming to WHC latency (or a time to transition associated with roaming between APs) may be needed, which may be caused by the user walking in a certain direction.

Earbuds (also referred to as sinks) may need to be time aligned to less than one sample, meaning timestamps may be coordinated between earbuds. Such coordination may force control to be done at the UE. System constraints may cause the control to reside at the UE (e.g., a source), which means that the UE may signal the earbuds independently because there may be no signal path between the earbuds. Regardless of a number of physical or virtual radios, the two transport paths may present different latencies (e.g., BLE latency is different from Wi-Fi latency). Packet loss concealment may need to mask any missing packets, and timestamps may be used to determine a precise duration of any missing audio. Further, latency control words (LCWs) may be used to determine when to account for audio stretching.

In various aspects of techniques and apparatuses described herein, an audio stream decoder may receive, from an audio stream encoder, an audio stream. The audio stream decoder may receive, from the audio stream encoder, latency control signaling to adjust latency for the audio stream, where the latency may be adjusted based at least in part on a time modification of audio in the audio stream. The audio stream decoder may apply the time modification to stretch the audio in the audio stream, where stretched audio may be associated with added latency. The audio stream decoder may apply the time modification to contract the audio in the audio stream, where contracted audio may be associated with reduced latency. The audio stream decoder may adjust, based at least in part on the latency control signaling, the latency using a combination of a FROLA time modification algorithm and a WSOLA time modification algorithm. The audio stream decoder may select, from a buffer of un-played audio, a section of audio in the audio stream to repeat using the WSOLA time modification algorithm. The audio stream decoder may build the buffer of un-played audio using the FROLA time modification algorithm. A switch between the FROLA time modification algorithm and the WSOLA time modification algorithm may be associated with a latency adjustment. The latency control signaling may include an indication of one or more timestamps at which one or more time modifications are to be applied to the audio stream, where the latency control signaling may be to control and synchronize the one or more time modifications at the audio stream decoder. The latency control signaling may include one or more latency control words, where the audio stream decoder may perform a packet loss concealment for packet loss and time correction based at least in part on the one or more latency control words.

In some aspects, the audio stream encoder may be associated with latency control logic and time synchronization, and the audio stream decoder may be associated with multiple time modification algorithms. The latency may be adjusted prior to a switch between APs to avoid an interruption in the audio stream during the switch between the APs, where the latency may be adjusted without a pitch change in the audio stream. The audio stream encoder and the audio stream decoder may be associated with an XPAN. The audio stream decoder may be associated with a pair of earbuds.

In some aspects, the XPAN may allow roaming to and between Wi-Fi APs with no perceptible audio effects. To support moving to and between APs, latency may be increased significantly over a short period, as it is not possible to achieve high rates of changes required using an SRC, which introduces a noticeable pitch change. Two algorithms, WSOLA and FROLA, may be used to support moving to and between APs without the use of the SRC. WSOLA may be used to stretch audio in a time domain to add latency, where WSOLA does not have any noticeable pitch change. As WSOLA requires a buffer of un-played audio to operate, FROLA may be used to initially increase the latency required before enabling WSOLA.

In some aspects, although the SRC may be used to adjust an end-to-end latency, SRC may be limited to a maximum rate of 5 ms/second of change because SRC may introduce a pitch change which is noticeable at faster rates. The use of WSOLA and FROLA may allow for fast latency changes. WSOLA may allow for rapid latency changes of up to approximately 150 ms/second by repeating a small section of audio, which may eliminate the noticeable pitch change and thus make the time stretching of audio imperceivable. Other time modification algorithms besides WSOLA and/or FROLA may be suitable, for example, phase vocoders, granular synthesis, time-domain synchronous overlap-add (TDSOLA), dynamic time warping (DTW), or WaveNet based approaches using deep learning models. A combination of such time modification algorithms may be employed for latency adjustment. The time modification algorithms may include time-stretching algorithms and/or time-contracting algorithms.

In some aspects, WSOLA may be used to select a section of audio to repeat that will maintain a fundamental pitch of the audio, which makes the selection content-dependent. WSOLA may allow an alignment with timestamps and synchronize to both earbuds, while integration into a viable working system that can synchronize two earpieces may result in a large amount of control and signaling complexity. WSOLA may require a buffer of un-played audio to act on, so WSOLA cannot be used alone without buffered audio, which would add latency. FROLA may be used to build an initial buffer of un-played audio as well as remove the un-played audio, as FROLA has the advantage of having zero algorithmic delay. Further, an encoder may control latency and determine which algorithm the decoder should employ, such that signaling may be embedded into a bitstream and encoder and decoder states may be synchronized.

In some aspects, time stretching algorithms like WSOLA may be used in open-source musical applications to time stretch and pitch shift audio. WSOLA may be used to align audio and apply a pitch bending effect. WSOLA may also be used in other applications as diverse as audio forensics and machine learning. Such uses of WSOLA do not include the application to latency adjustment. In some aspects, WSOLA may be used to better align to a timestamp and phase difference between earbuds. Such an approach may be needed for an XPAN to support having a pair of Wi-Fi enabled earbuds that are able to seamlessly roam between APs and between BLE and Wi-Fi. In some aspects, while latency adjustment may be done using an SRC, this approach may affect the pitch of the audio and may be limited to adjusting latency at 5 ms/second. WSOLA may allow the stretching of audio up to 150 ms/second without any noticeable pitch change, which gives perceptual transparency to a listener that is needed when significantly increasing latency for the XPAN. In some aspects, limitations associated with buffer requirements normally needed for WSOLA may be addressed. By using time modification algorithms (e.g., FROLA and WSOLA) applied to latency adjustment, low latency audio may be delivered while briefly increasing the latency for the transition between APs, which may minimize any perception of the latency change to the user. Other techniques for adding latency, such as SRC, may modify the signal pitch and thus are perceivable to the listener. WSOLA may repeat sections of audio and pitch matches to align the sections of audio, which may allow for a 150 ms/second or more change in latency.

In some aspects, the use of time modification algorithms (e.g., FROLA and WSOLA) applied to latency adjustment may be applicable for XPAN WHC and clock synchronization across multiple APs. Earbuds may have an ability to maintain a clock synchronized to the UE. The clock synchronization may allow for a simple synchronization of audio rendering between earbuds. Such an approach may be used when moving from gaming to roaming over an AP. Further, placing the time stretching at the synchronization provides compatibility with different audio codecs, as these audio codecs may not have a mechanism to dynamically adapt their frame size.

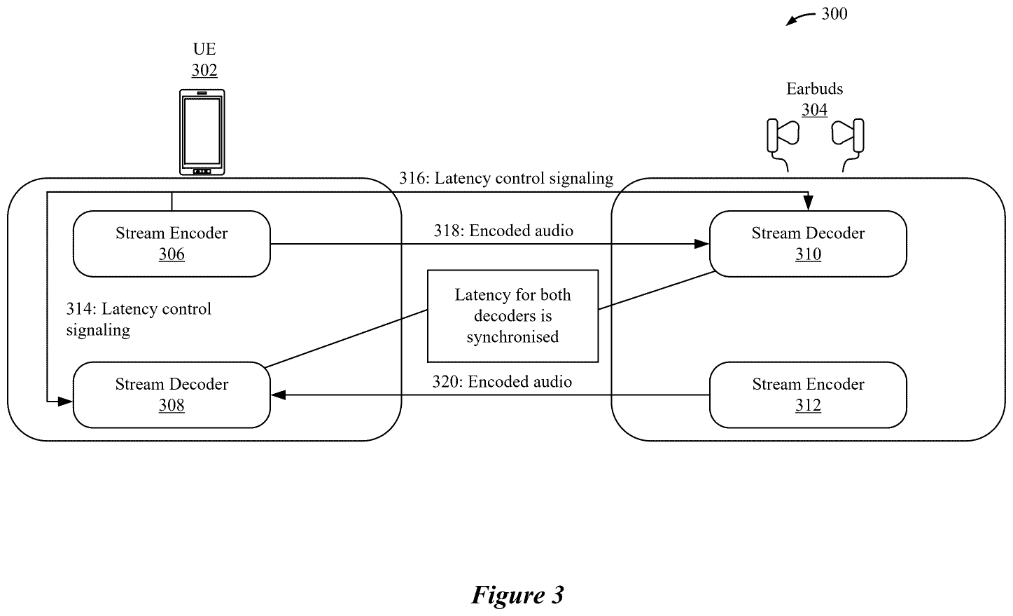

FIG. 3 is a diagram of an example 300 of synchronization and control of multiple earbuds, in accordance with the present disclosure.

FIG. 3 illustrates an example of a UE 302 connected to a pair of earbuds 304. As further shown in FIG. 3, a UE 302 may include a stream encoder 306 and a stream decoder 308. Each earbud 304 may include a stream decoder 310 and a stream encoder 312. As illustrated at 314 and 316, respectively, the stream encoder 306 at the UE 302 may transmit latency control signaling to the stream decoder 308 at the UE 302 and the stream decoder 310 at the earbuds 304. In some aspects, a latency for the stream decoder 308 and the stream decoder 310 may be synchronized. For example, in the case of a bidirectional communications link, streams in both directions may have the same latency adjustment in order to reduce or eliminate perceptible audio issues when latency is adjusted. The stream encoder 306 at the UE 302 may control the stream decoders at both the UE 302 and the earbuds 304 via the latency control signaling illustrated at 314 and 316. Thus, some aspects may include a signaling architecture where there are direct signal paths to both the stream decoder 308 and the stream decoder 310 from the stream encoder 306; and, in some aspects, no direct path may exist between the stream encoder 306 at the UE 302 and the stream encoder 312 at the earbuds 304.

As illustrated at 318, the stream encoder 306 at the UE 302 may transmit encoded audio to the stream decoder 310 at the earbuds 304. As illustrated at 320, the stream encoder 312 at the earbuds 304 may transmit encoded audio to the stream decoder 308 at the UE 302.

As described in more detail herein, in some aspects, a switching event (e.g., a switching between APs), may cause a sudden degradation of a link. When an upcoming switching event is detected, buffered data at the earbuds 304 may be stretched to allow the link more time for recovery. In other words, prior to the sudden degradation of the link (e.g., due to switching between APs), the buffered data at the earbuds 304 may be stretched to increase latency at the earbuds 304. The increased latency may allow additional time for the link between the earbuds 304 and the UE 302 to recover. Similarly, when switching between latency requirements (e.g., when switching from a gaming application to a non-gaming application), buffered data at the earbuds 304 may be stretched to increase the latency, which may cause an imperceptible change in audio to a listener associated with the UE 302.

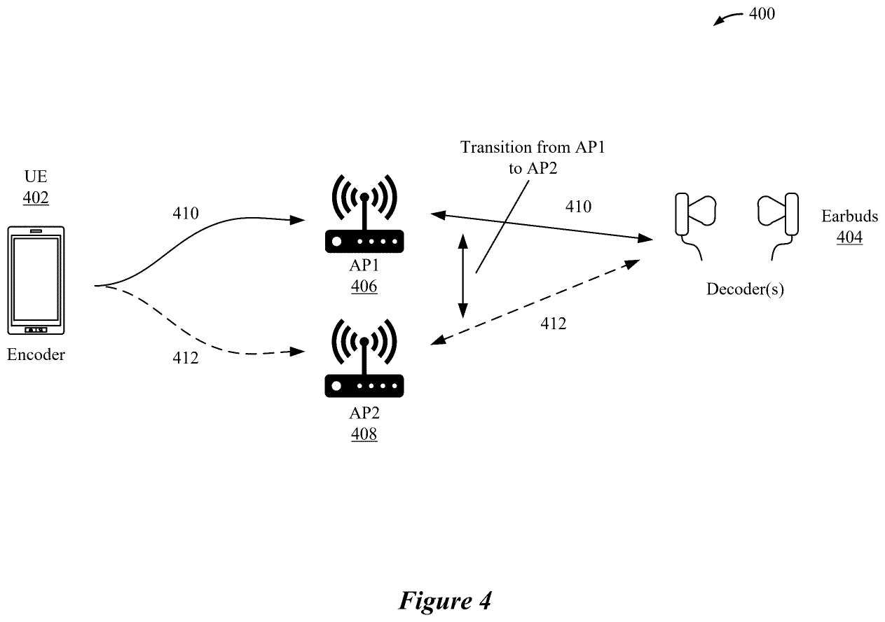

FIG. 4 is a diagram of an example 400 of audio streaming between a UE 402 and earbuds 404, in accordance with the present disclosure. For example, FIG. 4 illustrates a UE 402, earbuds 404, a first AP 406 (AP1), and a second AP 408 (AP2). The UE 402 may be an audio stream encoder. The earbuds 404 may be an audio stream decoder or an audio device. As described herein, the UE 402 may include an encoder with latency control logic and time synchronization, and the earbuds 404 may include respective decoders that may execute one or more time modification algorithms.

As shown in FIG. 4 at 410, a UE 402 may transmit/receive audio to/from earbuds 404 via the first AP 406. As illustrated at 412, during the communications via the first AP 406, the UE 402 and/or the earbuds 404 may transition from communicating via the first AP 406 to communicating via the second AP 408. During the transition from the first AP 406 to the second AP 408, an authentication to the AP 408 may block usage of the first AP 406. In this case, extra buffering (or latency) may be performed on the earbuds 404 to avoid interruption in the audio. Accordingly, and as described herein, the earbuds 404 may use the time modification algorithms to adjust the latency and the UE 402 may provide control signaling for time synchronization.

In some aspects, the UE 402 may detect a switching event (e.g., an upcoming switching event) that is to be associated with the UE 402. The switching event may involve the UE 402 moving from the first AP 406 to the second AP 408. In other words, the switching event may involve the UE 402 transitioning between two APs. The UE 402 may detect that the switching event is about to occur based at least in part on a signal quality associated with the first AP 406 and/or the second AP 408. For example, when a signal quality associated with the first AP 406 is less than a threshold and a signal quality associated with the second AP 408 is greater than the threshold, the UE 402 may determine that the switching event is likely to occur. In some aspects, the UE 402 may determine whether signaling associated with key exchange, authentication, or other processes have been initiated with the second AP 408, which may indicate that the UE 402 is to switch from the first AP 406 to the second AP 408.

In some aspects, after the UE 402 detects the switching event that is to occur, the UE 402 may transmit the control signaling to the earbuds 404. The control signaling may be latency control signaling. The latency control signaling may enable the earbuds to maintain synchronization between different audio channels associated with the earbuds 404. For example, the latency control signaling may enable synchronization between a first audio channel associated with a first earbud and a second audio channel associated with a second earbud. The latency control signaling may enable the earbuds 404 to adjust latency for an audio stream using a combination of multiple time modification algorithms.

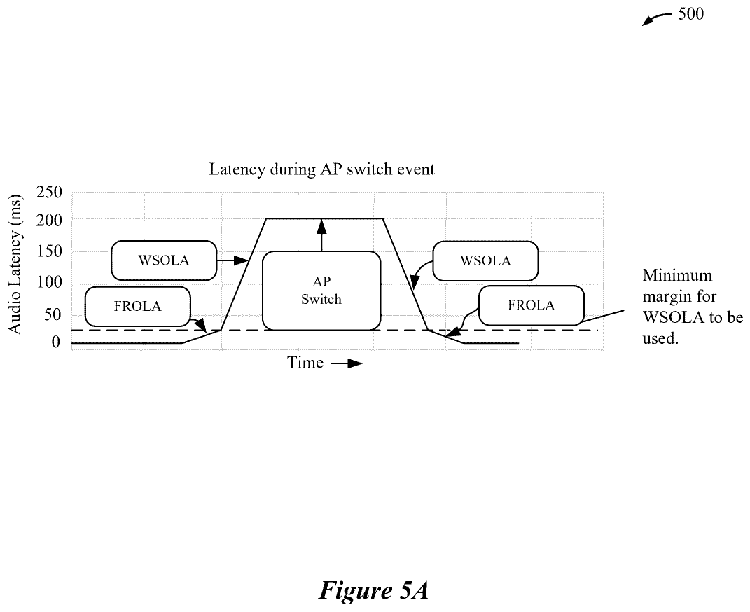

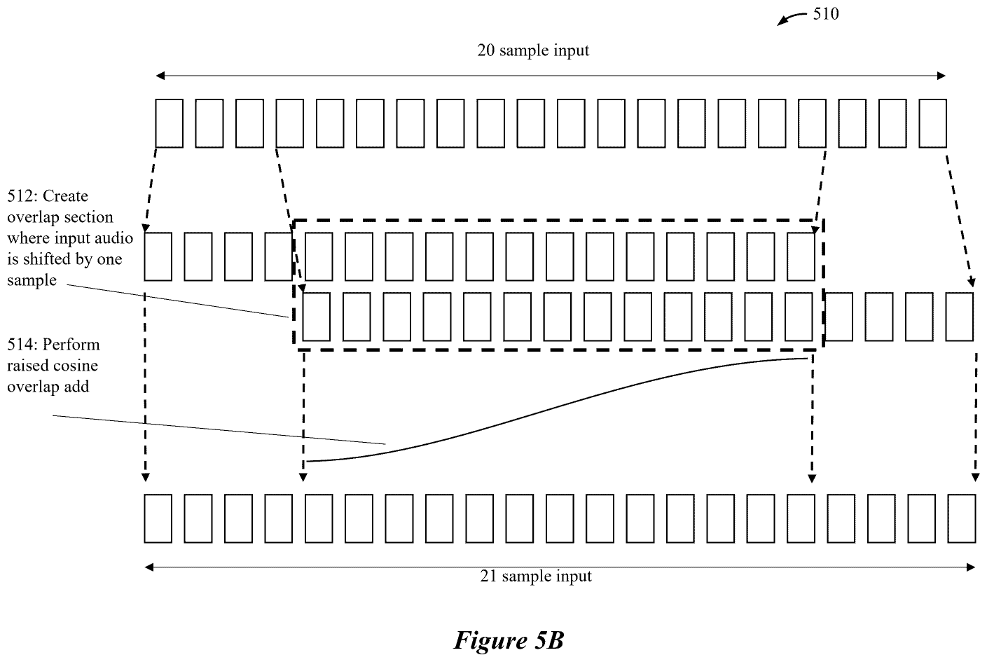

FIG. 5A is a diagram of an example 500 of latency during an AP switch event, in accordance with the present disclosure.

As shown in FIG. 5A, an audio latency may be monitored by an audio device (e.g., a pair of earbuds 404) over time. The audio latency may be associated with a pattern of additional latency adjustment as a system switches between FROLA and WSOLA. For example, the audio latency may increase when switching from FROLA to WSOLA, which may enable the audio latency to be flat during an AP switch event. The audio latency may decrease when switching from WSOLA to FROLA.

In some aspects, a minimum latency margin (e.g., 22 ms) may be needed to use WSOLA. In some aspects, the use of FROLA and then switching to WSOLA may result in a distinctive fingerprint in an audio stream. For example, a duration and rate of change may follow a pattern with a slow rate of change associated with FROLA transitioning to a faster rate of change associated with WSOLA once the minimum latency margin needed for WSOLA is reached. Reducing latency after the switch may have the opposite signature (e.g., where WSOLA to decrease latency to the minimum latency margin for WSOLA, and FROLA is then used to further reduce latency). The use of FROLA may create a window of inserted signal samples, whereas the use of WSOLA may create a window of repeated sections of audio. In this way, a fingerprint of both algorithms may be present in the audio.

In addition, some aspects may include signaling that may be present. For example, active algorithm durations may be controlled from a UE, and the signaling may be present in the audio stream. Furthermore, WSOLA may involve sending messages to instruct the earbuds to start buffering audio for the switch to WSOLA. Further, a timestamp generated by an encoder may account for time modification due to adjusting latency and the timestamps for different earbuds may not match until the earbuds apply an appropriate algorithm.

FIG. 5B is a diagram of an example 510 of a FROLA time modification algorithm.

As shown in FIG. 5B, a 20 sample input may be received. As shown by reference number 512, when the FROLA time modification algorithm is applied, an overlap section may be created, where an input audio may be shifted by one sample. As shown by reference number 514, when the FROLA time modification algorithm is applied, a raised cosine overlap add may be performed. As a result, a 21 sample input may be produced, where the overlap section may result in a latency adjustment that is not perceptible.

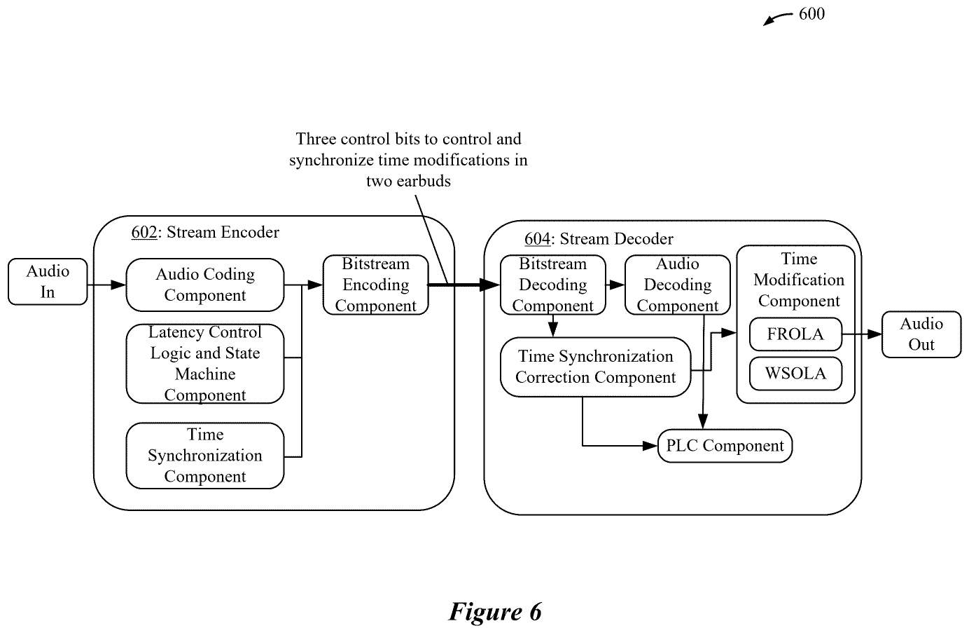

FIG. 6 is a diagram of an example 600 of signaling control bits to control and synchronize time modifications in two earbuds, in accordance with the present disclosure. For example, FIG. 6 illustrates a stream encoder 602 of a UE and a stream decoder 604 of earbuds.

As shown in FIG. 6, a stream encoder 602 may include an audio coding component that receives audio (audio in), a bitstream encoding component, a latency control logic and state machine component, and a time synchronization component. The latency control logic and state machine component may control time modification. For example, the latency control logic and state machine component may compute a timestamp and then insert the timestamp into an audio stream so that both earbuds maintain synchronization. In some aspects, the latency control logic and state machine component may use a timestamp to compute and align any latency changes. During the bitstream encoding, the bitstream encoding component may add a set of control bits (e.g., three control bits) to a packet header to control and synchronize the time modifications in the audio device (e.g., in two earbuds).

As further shown in FIG. 6, a stream decoder 604 may include a bitstream decoding component, an audio decoding component, a time synchronization correction component, a packet loss concealment (PLC) component, and a time modification component that uses FROLA and WSOLA. The time modification component may output audio (audio out). The PLC component may be used for packet loss and time correction. The WSOLA may use a function, where the function may include a target timestamp in packet (TTP) (e.g., so that two earbuds remain synced). When using the TTP, the stream encoder 602 may calculate timestamps with the time modification (stretching) applied. In the audio outputted from the stream decoder 604, the control bits may be used to control an amount of audio that an audio output buffer retains, to enable a switch between FROLA and WSOLA.

In some aspects, the stream encoder 602 may be associated with complex signaling and control logic, where the complexity may derive from combining two algorithms with different latencies. For example, starting and stopping each algorithm may require precise alignment of a time modified output signal with an original signal. Additionally, or alternatively, the stream decoder 604 may handle complex buffer arrangements to achieve latency control. For example, the stream decoder 604 may perform buffer management using a separate state machine driven control logic.

In some aspects, such an approach may allow up to 150 milliseconds (ms)/second without any pitch change problems that are associated with SRC. SRC may limit a rate of change of sampling to 25 ms/second, and this rate of change may be associated with a small perceivable pitch change.

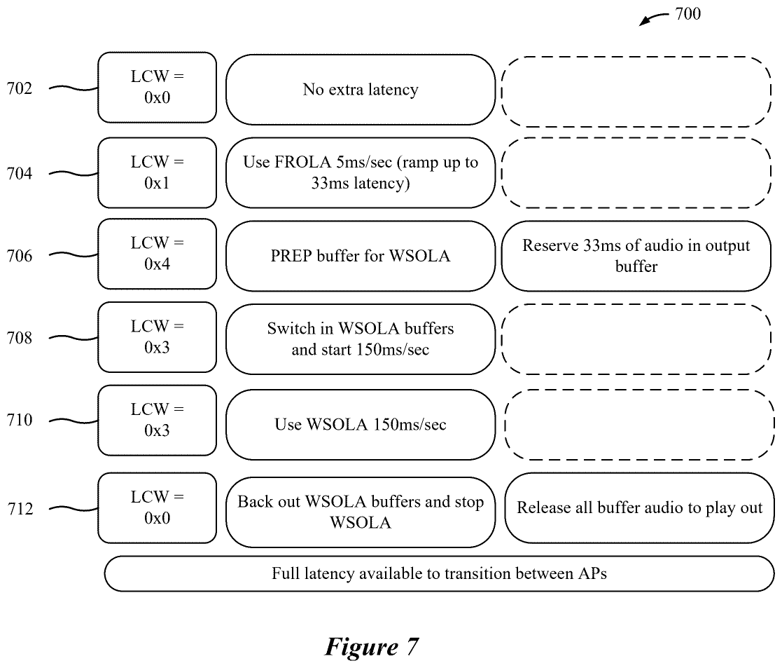

FIG. 7 is a diagram of an example 700 of three control bits associated with increasing latency, in accordance with the present disclosure.

In some aspects, a stream encoder at a UE may transmit an LCW to two earbuds. The stream encoder at the UE may also transmit the LCW to a stream decoder at the UE (a local decoder) (e.g., for a microphone return path). The LCW may be used to synchronize the stream decoder at the UE 302 and the stream decoder at the earbuds (e.g., all decoders) and allow for a packet loss concealment to correctly recover.

As shown in FIG. 7, a three-bit LCW may be used to control a time stretching. While FROLA is running, an audio sample associated with extra latency may not be stored, and all audio may be passed to a next stage. In this example, as shown by reference number 702, LCW=0×0 may be associated with no extra latency. As shown by reference number 704, LCW=0×1 may be associated with using FROLA at 5 ms/second (increase to 33 ms latency). As shown by reference number 706, LCW=0×4 may be associated with preparing a buffer for WSOLA (e.g., reserving 33 ms of audio in an output buffer). As shown by reference number 708, LCW=0×3 may be associated with switching in WSOLA buffers (e.g., starting WSOLA buffering) and starting WSOLA at 150 ms/second. As shown by reference number 710, LCW=0×3 may be associated with using WSOLA at 150 ms/second. As shown by reference number 712, LCW=0×0 may be associated with backing out WSOLA buffers (e.g., clearing or emptying the WSOLA buffers) and stopping WSOLA, which may involve releasing all buffer audio to an output. In these aspects, an LCW may indicate no change, an increasing latency, a preparing of buffering, or decreasing latency.

In some aspects, full latency may be available to transition between APs. For example, LCW=0×4 may be used to prepare the 33 ms buffer needed for WSOLA to switch in, and audio may be held inside the block for only that LCW.

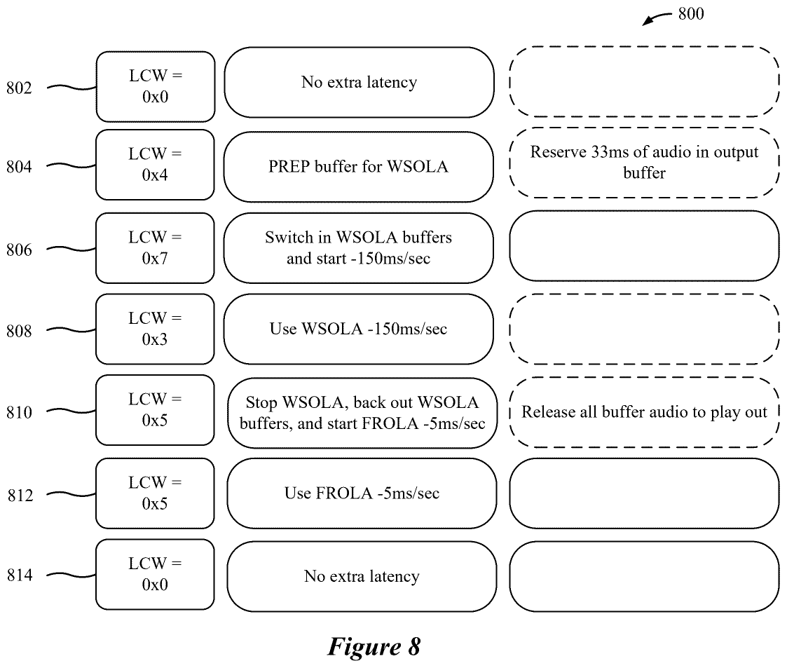

FIG. 8 is a diagram of an example 800 of three control bits associated with decreasing latency, in accordance with the present disclosure.

As shown in FIG. 8, a three-bit LCW may be used to control a reduction of latency. In this example, as shown by reference number 802, LCW=0×0 may be associated with no extra latency (or full latency). As shown by reference number 804, LCW=0×4 may be associated with preparing a buffer for WSOLA (e.g., reserving 33 ms of audio in an output buffer). In this example, LCW=0×4 may be used to prepare the 33 ms buffer needed for WSOLA to switch in. As shown by reference number 806, LCW=0×7 may be associated with switching in WSOLA buffers and start WSOLA at −150 ms/second. As shown by reference number 808, LCW=0×3 may be associated with using WSOLA at −150 ms/second. As shown by reference number 810, LCW=0×5 may be associated with stopping WSOLA and backing out WSOLA buffers and starting FROLA at −5 ms/second (which may involve releasing all buffer audio to play out). As shown by reference number 812, LCW=0×5 may be associated with using FROLA at −5 ms/second. As shown by reference number 814, LCW=0×0 may be associated with no extra latency.

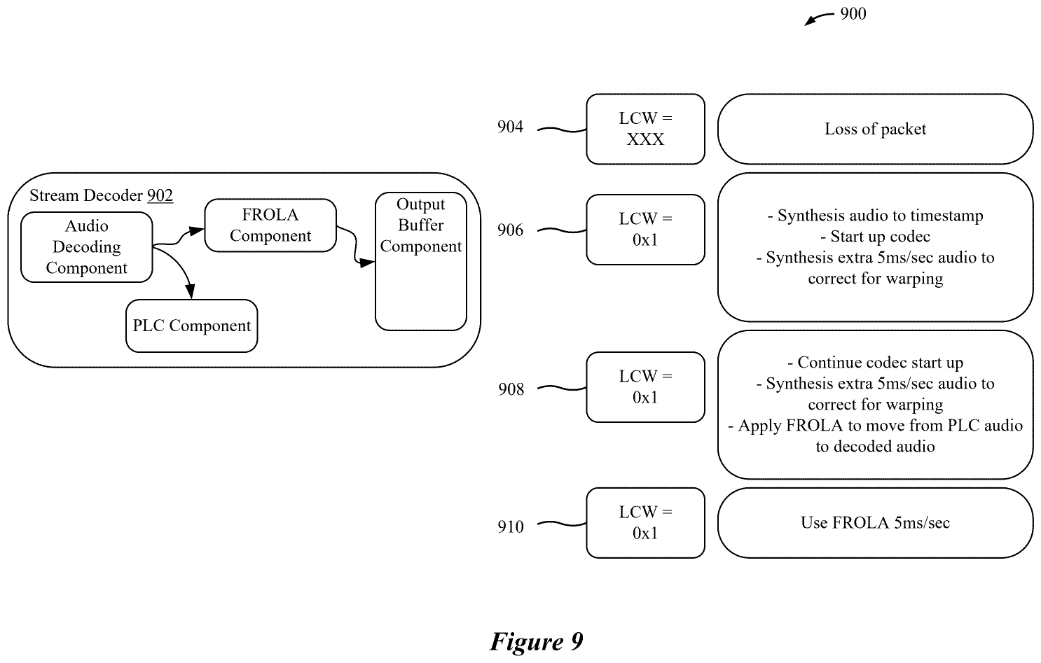

FIG. 9 is a diagram of an example 900 of audio decoding, in accordance with the present disclosure.

In some aspects, a stream decoder 902 at earbuds may be associated with an audio decoding component. The audio decoding component may be associated with a FROLA component and a packet loss concealment (PLC) component. The FROLA component may be used for applying FROLA. The packet loss concealment component may be used for providing a packet loss concealment. The FROLA component may be associated with an output buffer component. The output buffer component may provide an output.

In some aspects, to recover from packet loss, an LCW may be used to select a correct handling for packet loss concealment. Since FROLA may be associated with zero latency, the packet loss concealment may involve synthesizing audio to a timestamp (e.g., an algorithmic latency of a codec). More than one packet may account for the codec latency. The packet loss concealment may involve using an LCW to synthesize extra audio depending on the LCW that is received. For a 5 ms/second rate of change (LCW=0×1), the packet loss concealment may involve adding an extra 2 samples per 10 ms packet, whereas 150 ms/second (LCW=0×3) may be associated with 48 samples. When FROLA is reenabled, the audio may match corresponding timestamps.

As shown by reference number 904, LCW=XXX may be associated with a loss of packet. As shown by reference number 906, LCW=0×1 may be associated with synthesizing audio to a timestamp, starting up a codec, and synthesizing an extra 5 ms/second audio to correct for warping. As shown by reference number 908, LCW=0×1 may be associated with continuing a codec startup, and synthesizing an extra 5 ms/second audio to correct for warping. LCW=0×1 may also be associated with applying FROLA to move from packet loss concealment audio to decoded audio. As shown by reference number 910, LCW=0×1 may be associated with using FROLA at 5 ms/second.

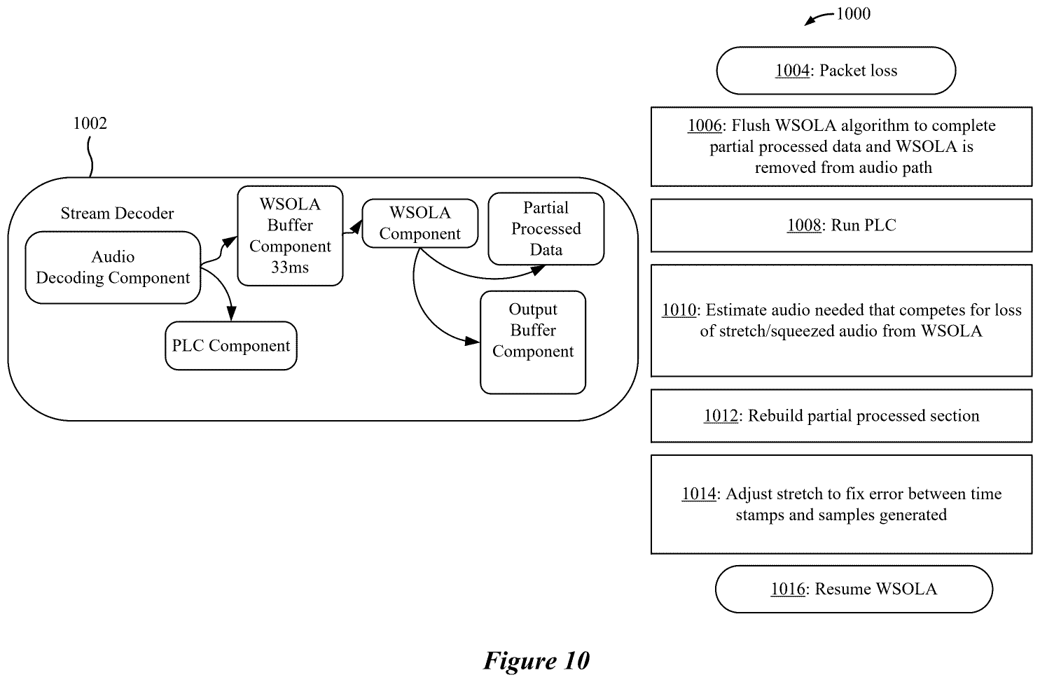

FIG. 10 is a diagram of an example 1000 of audio decoding, in accordance with the present disclosure.

In some aspects, a stream decoder 1002 at a pair of earbuds may be associated with an audio decoding component. The audio decoding component may be associated with a WSOLA buffer component (33 ms) and packet loss concealment component. The WSOLA buffer component may be used for applying WSOLA. The packet loss concealment component may be used for providing a packet loss concealment. The WSOLA buffer component may be associated with partial processed data and an output buffer component.

In some aspects, buffer requirements of WSOLA may make packet loss concealment handling complex. WSOLA may use a 33 ms input buffer and may hold partially processed data in the output buffer. A state machine (not shown in FIG. 10) used by the packet loss concealment may stop the WSOLA and flush audio through the WSOLA buffer to the output buffer. The state machine may synthesize missing audio, restart an audio codec and account for algorithmic latency of the audio codec, and then decode one or more packets to prepare the output buffer for WSOLA. The packet loss concealment may be applied in time before a WSOLA algorithm is applied, so the packet loss concealment is able to run on linear audio (e.g., packet loss concealment may capture an audio feed to a WSOLA algorithm). When a packet resumes, the packet loss concealment may involve accounting for a 150 ms/second rate of change by adding/removing extra samples (e.g., about 48 samples per 10 ms packet) to correctly align the audio to restart WSOLA. A stream encoder may send a message (e.g., via LCW) to stop WSOLA when recovering. In this case, the WSOLA may be backed out, and WSOLA may then be used to correct for an error between timestamps and samples produced. While the packet loss concealment is running and WSOLA is recovering, timestamps in a received packet may be ignored. Timestamps in the received packet may then only be used when the WSOLA has recovered.

As shown by reference number 1004, packet loss may be identified at the stream decoder. As shown by reference number 1006, a WSOLA algorithm may be flushed at the stream decoder to complete partially processed data and WSOLA may be removed from an audio path. As shown by reference number 1008, a packet loss concealment may be run at the stream decoder. As shown by reference number 1010, audio that competes for loss of stretched/contracted audio from WSOLA may be estimated at the stream decoder. As shown by reference number 1012, partially processed data may be rebuilt at the stream decoder. As shown by reference number 1014, a time stretch may be adjusted, at the stream decoder, to fix any error between timestamps and generated samples. As shown by reference number 1016, WSOLA may then be resumed at the stream decoder.

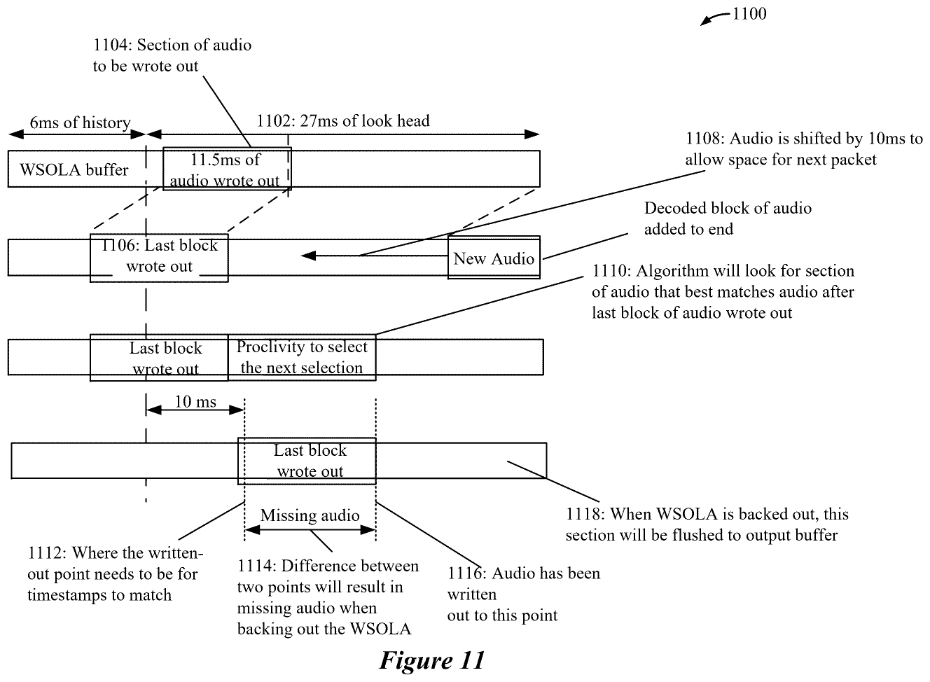

FIG. 11 is a diagram of an example 1100 of audio decoding, in accordance with the present disclosure. Blocks shown in FIG. 11 may represent a WSOLA buffer at different periods of time.

As shown in FIG. 11 at 1102, WSOLA may maintain an input buffer with a first duration of 27 ms of look ahead and a second duration of 6 ms of history. For example, and as illustrated at 1104, within the 27 ms of look ahead, a section of audio that has to be written out may be 11.5 ms in duration. As illustrated at 1106, the 11.5 ms section of audio may correspond to a last block written out, and as illustrated at 1108 audio may be shifted by 10 ms to allow space for a next packet (e.g., new audio, which may be a decoded block of audio added to the end). As illustrated at 1110, WSOLA may search for a section of audio that best matches the audio after the last block of audio written out, so WSOLA may have a proclivity to write out the next block in its buffer. When WSOLA is backed out, the audio that is flushed out is less than needed to match timestamps (missing audio). As illustrated at 1112, a written-out point may be defined for timestamps to match. As illustrated at 1114, a difference between two points may result in the missing audio when backing out the WSOLA. As illustrated at 1116, audio may be written out to a defined point. As illustrated at 1118, when WSOLA is backed out, a section may be flushed to an output buffer.

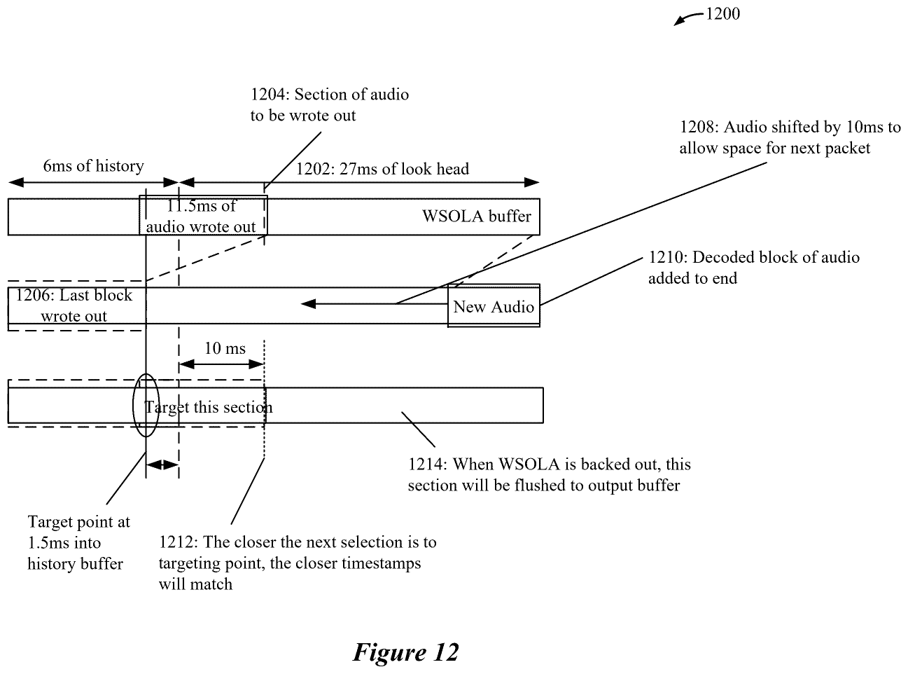

FIG. 12 is a diagram of an example 1200 of audio decoding, in accordance with the present disclosure.

As shown in FIG. 12, WSOLA may be modified to improve a timestamp alignment. As illustrated at 1202, WSOLA may maintain an input buffer with 27 ms of look ahead and 6 ms of history. For example, and as illustrated at 1204, within the 27 ms of look ahead, a section of audio that has to be written out may be 11.5 ms in duration. The 11.5 ms section of audio may be a section of audio that has to be written out. As illustrated at 1206, the 11.5 ms section of audio may correspond to a last block written out, and as illustrated at 1208, audio may be shifted by 10 ms to allow space for a next packet (e.g., new audio, which may be a decoded block of audio added to the end), as illustrated at 1210. When a section to be written out is closer to a target point, an amount of audio that is flushed when WSOLA is backed out may better align with a timestamp. A best match search may be modified to weight results to tend to a target point (e.g., a target point at 1.5 ms into a history buffer). As illustrated at 1212, when a next selection is closer to the target point, timestamps may better match with each other. A high weighting may be used on a last cycle in which WSOLA is run. A weighted search may reduce a phase difference between earbuds for music, which may limit results to +/−5 ms, and then FROLA may be used to obtain better values. As illustrated at 1214, when WSOLA is backed out, a certain section may be flushed to an output buffer.

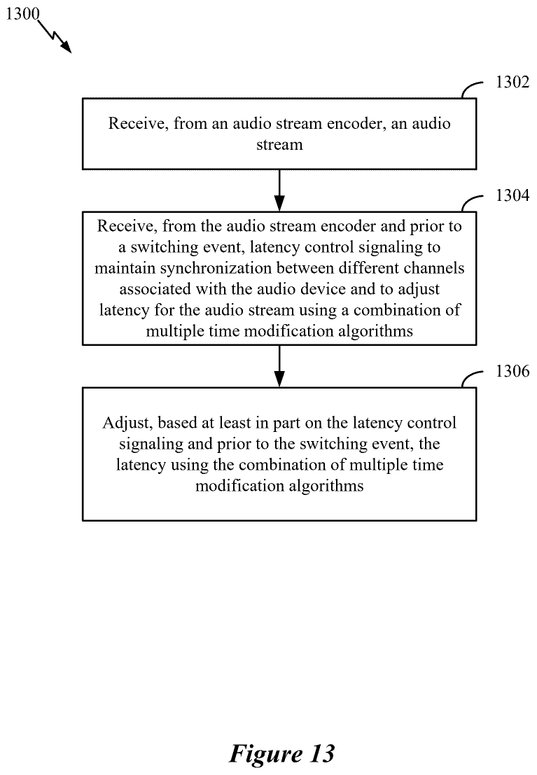

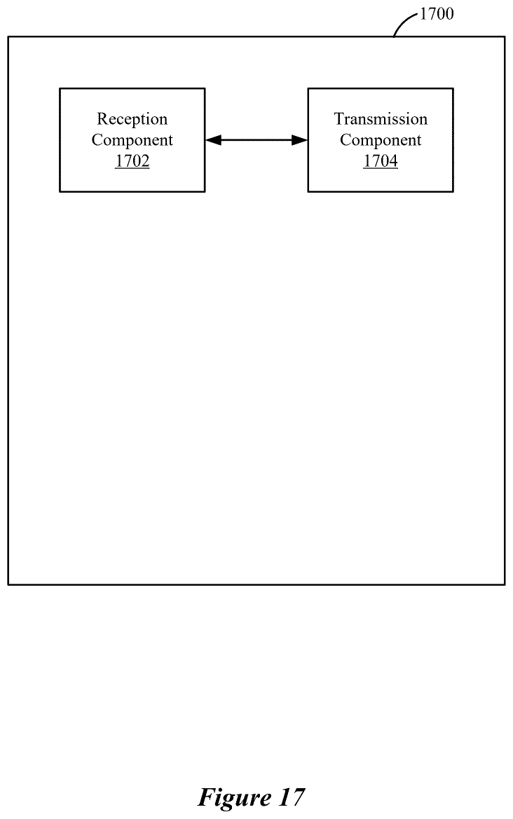

FIG. 13 is a flowchart illustrating an example process 1300 performable at an audio device that supports adjusting latency in audio streams according to some aspects of the present disclosure. The operations of the process 1300 may be implemented by the audio device or its components as described herein. For example, the process 1300 may be performed by a wireless communication device, such as the wireless communication device 1700 described with reference to FIG. 17, operating as or within a wireless AP.

In some examples, in block 1302, process 1300 may include receiving, from an audio stream encoder (e.g., an STA), an audio stream. In some examples, in block 1304, process 1300 may include receiving, from the audio stream encoder and prior to a switching event, latency control signaling to maintain synchronization between different audio channels associated with the audio device and to adjust latency for the audio stream using a combination of multiple time modification algorithms. In some examples, in block 1306, process 1300 may include adjusting, based at least in part on the latency control signaling and prior to the switching event, the latency using the combination of multiple time modification algorithms.

In a first aspect, process 1300 includes applying a time modification to stretch audio in the audio stream, wherein the stretched audio is associated with added latency, or applying a time modification to contract the audio in the audio stream, wherein the contracted audio is associated with reduced latency.

In a second aspect, alone or in combination with the first aspect, process 1300 includes adjusting, based at least in part on the latency control signaling, the latency using a combination of a FROLA time modification algorithm and a WSOLA time modification algorithm.

In a third aspect, alone or in combination with one or more of the first and second aspects, process 1300 includes building a buffer of un-played audio using the FROLA time modification algorithm selecting, from the buffer of un-played audio, a section of audio in the audio stream to repeat using the WSOLA time modification algorithm.

In a fourth aspect, alone or in combination with one or more of the first through third aspects, a switch between the FROLA time modification algorithm and the WSOLA time modification algorithm is associated with a latency adjustment.

In a fifth aspect, alone or in combination with one or more of the first through fourth aspects, the latency control signaling includes an indication of one or more timestamps at which the time modification is to be applied to the audio stream, and the latency control signaling is to control and synchronize the time modification at the audio stream decoder.

In a sixth aspect, alone or in combination with one or more of the first through fifth aspects, the latency control signaling includes one or more latency control words, and process 1300 includes performing a packet loss concealment for packet loss and time correction based at least in part on the one or more latency control words, wherein the time correction is achieved using timestamps after the packet loss concealment.

In a seventh aspect, alone or in combination with one or more of the first through sixth aspects, the audio stream encoder is associated with latency control logic and time synchronization, and the audio device is associated with multiple time modification algorithms.

In an eighth aspect, alone or in combination with one or more of the first through seventh aspects, the switching event is a switch of the audio device between access points and the latency is adjusted prior to the switch between access points.

In a ninth aspect, alone or in combination with one or more of the first through eighth aspects, the switching event is the audio device moving from a first latency environment, or connection, or context to a second latency environment, connection, or context.

In a tenth aspect, alone or in combination with one or more of the first through ninth aspects, the audio device is associated with an XPAN.

In an eleventh aspect, alone or in combination with one or more of the first through tenth aspects, the audio device comprises a pair of earbuds.

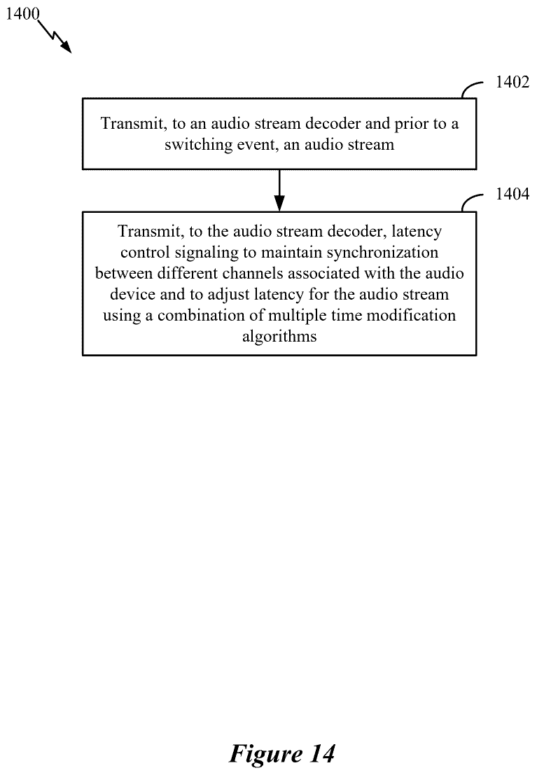

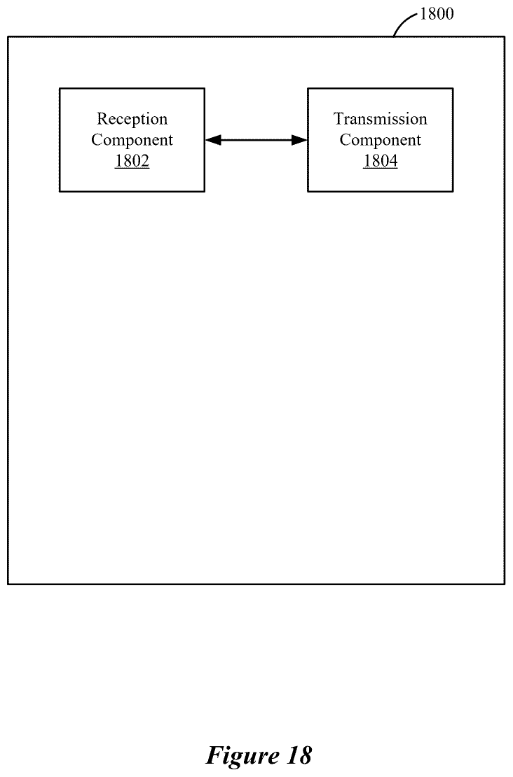

FIG. 14 is a flowchart illustrating an example process 1400 performable at a mobile station (e.g., an STA) that supports adjusting latency in audio streams according to some aspects of the present disclosure. The operations of the process 1400 may be implemented by a wireless STA or its components as described herein. For example, the process 1400 may be performed by a wireless communication device, such as the wireless communication device 1800 described with reference to FIG. 18, operating as or within a wireless STA. In some examples, the process 1400 may be performed by a wireless STA such as one of the STAs 104 described with reference to FIG. 1.

In some examples, in block 1402, process 1400 may include transmitting, to an audio stream decoder (e.g., an audio device) and prior to a switching event, an audio stream. In some examples, in block 1404, process 1400 may include transmitting, to the audio stream decoder, latency control signaling to maintain synchronization between different audio channels associated with the audio stream decoder and to adjust latency for the audio stream using a combination of multiple time modification algorithms.

In a first aspect, a time modification is associated with a stretching of the audio in the audio stream, and the stretched audio is associated with added latency; or a time modification is associated with a contraction of the audio in the audio stream, and the contracted audio is associated with reduced latency.

In a second aspect, alone or in combination with the first aspect, the latency is adjusted based at least in part on a combination of a FROLA time modification algorithm and a WSOLA time modification algorithm.

In a third aspect, alone or in combination with one or more of the first and second aspects, a buffer of un-played audio is built using the FROLA time modification algorithm, and a section of audio in the audio stream is selected, from the buffer of un-played audio, to repeat using the WSOLA time modification algorithm.

In a fourth aspect, alone or in combination with one or more of the first through third aspects, a switch between the FROLA time modification algorithm and the WSOLA time modification algorithm is associated with a latency adjustment.

In a fifth aspect, alone or in combination with one or more of the first through fourth aspects, process 1400 includes calculating one or more timestamps at which a time modification is to be applied to the audio stream, wherein the latency control signaling is to control and synchronize the time modification at the STA, and the one or more timestamps are indicated in the latency control signaling.

In a sixth aspect, alone or in combination with one or more of the first through fifth aspects, the latency control signaling includes one or more latency control words, and a packet loss concealment for packet loss and time correction is based at least in part on the one or more latency control words.

In a seventh aspect, alone or in combination with one or more of the first through sixth aspects, the STA is associated with latency control logic and time synchronization.

In an eighth aspect, alone or in combination with one or more of the first through seventh aspects, the switching event is a switch of the STA between access points and the latency is adjusted prior to the switch between access points to avoid an interruption in the audio stream during the switch between the access points, and the latency is adjusted without a pitch change in the audio stream.

In a ninth aspect, alone or in combination with one or more of the first through eighth aspects, the switching event is the STA moving from a first latency environment, or connection, or context to a second latency environment, connection, or context.

In a tenth aspect, alone or in combination with one or more of the first through ninth aspects, the STA is associated with an XPAN.

In an eleventh aspect, alone or in combination with one or more of the first through tenth aspects, the audio stream decoder is associated with a pair of earbuds.

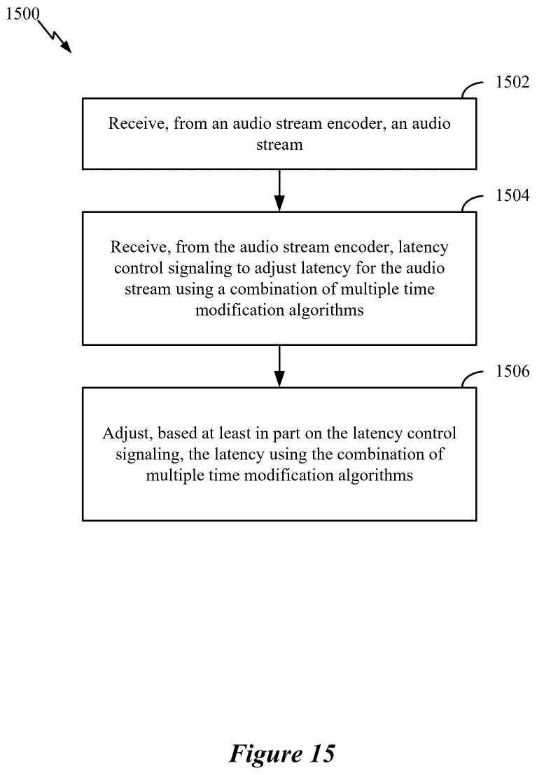

FIG. 15 is a flowchart illustrating an example process 1500 performable at an audio device that supports adjusting latency in audio streams according to some aspects of the present disclosure. The operations of the process 1500 may be implemented by the audio device or its components as described herein. For example, the process 1500 may be performed by a wireless communication device, such as the wireless communication device 1700 described with reference to FIG. 17, operating as or within a wireless AP.

In some examples, in block 1502, process 1500 may include receiving, from an audio stream encoder (e.g., an STA), an audio stream. In some examples, in block 1504, process 1500 may include receiving, from the audio stream encoder, latency control signaling to adjust latency for the audio stream using a combination of multiple time modification algorithms. In some examples, in block 1306, process 1300 may include adjusting, based at least in part on the latency control signaling, the latency using the combination of multiple time modification algorithms.

In a first aspect, process 1500 includes maintaining synchronization between different audio channels associated with the audio device based at least in part on the latency control signaling, wherein the different audio channels include a first audio channel and a second audio channel.

In a second aspect, alone or in combination with the first aspect, the latency is adjusted prior to a switching event, and the switching event is associated with a switch of the audio device between APs.

In a third aspect, alone or in combination with one or more of the first through second aspects, the latency is adjusted prior to a switching event, and the switching event is associated with the audio device moving from a first latency environment, a first connection, or a first context to a second latency environment, a second connection, or a second context.

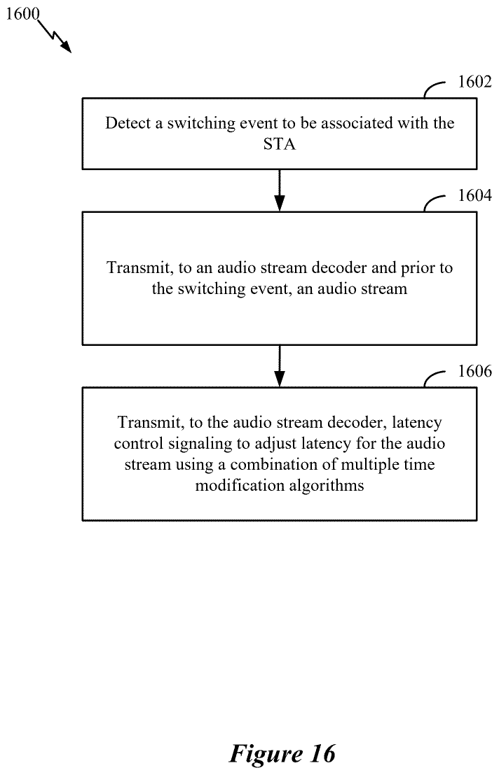

FIG. 16 is a flowchart illustrating an example process 1600 performable at a mobile station (e.g., an STA) that supports adjusting latency in audio streams according to some aspects of the present disclosure. The operations of the process 1600 may be implemented by a wireless STA or its components as described herein. For example, the process 1600 may be performed by a wireless communication device, such as the wireless communication device 1800 described with reference to FIG. 18, operating as or within a wireless STA. In some examples, the process 1600 may be performed by a wireless STA such as one of the STAs 104 described with reference to FIG. 1.

In some examples, in block 1602, process 1600 may include detecting a switching event to be associated with the STA. In some examples, in block 1604, process 1600 may include transmitting, to an audio stream decoder (e.g., an audio device) and prior to the switching event, an audio stream. In some examples, in block 1606, process 1600 may include transmitting, to the audio stream decoder, latency control signaling to adjust latency for the audio stream using a combination of multiple time modification algorithms.

In a first aspect, the switching event is associated with a switch of the STA between APs and the latency is adjusted prior to the switch between the APs to avoid an interruption in the audio stream during the switch between the APs; the latency is adjusted without a pitch change in the audio stream; or the switching event is associated with the STA moving from a first latency environment, or connection, or context to a second latency environment, connection, or context.

FIG. 17 is a block diagram of an example wireless communication device 1700 that supports adjusting latency in audio streams according to some aspects of the present disclosure. In some examples, the wireless communication device 1700 is configured or operable to perform the process 1300 described with reference to FIG. 13 and/or the process 1500 described with reference to FIG. 15. In some examples, the wireless communication device 1700 can be a device, such as an audio device. In some other examples, the wireless communication device 1700 can be an audio device that includes a chip, SoC, chipset, package or device as well as multiple antennas. The wireless communication device 1700 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1700 also includes or can be coupled with an application processor which may be further coupled with another memory. In some examples, the wireless communication device 1700 further includes at least one external network interface that enables communication with a core network or backhaul network to gain access to external networks including the Internet.

The wireless communication device 1700 includes a reception component 1702 and a transmission component 1704. Portions of one or more of the components 1702 and 1704 may be implemented at least in part in hardware or firmware. In some examples, at least some of the components 1702 and 1704 are implemented at least in part by a processor and as software stored in a memory. For example, portions of one or more of the components 1702 and 1704 can be implemented as non-transitory instructions (or “code”) executable by the processor to perform the functions or operations of the respective module.

In some aspects, the processor may be a component of a processing system. A processing system may generally refer to a system or series of machines or components that receives inputs and processes the inputs to produce a set of outputs (which may be passed to other systems or components of, for example, the device 1700). For example, a processing system of the device 1700 may refer to a system including the various other components or subcomponents of the device 1700, such as the processor, or a transceiver, or a communications manager, or other components or combinations of components of the device 1700. The processing system of the device 1700 may interface with other components of the device 1700, and may process information received from other components (such as inputs or signals) or output information to other components. For example, a chip or modem of the device 1700 may include a processing system, a first interface to output information and a second interface to obtain information. In some implementations, the first interface may refer to an interface between the processing system of the chip or modem and a transmitter, such that the device 1700 may transmit information output from the chip or modem. In some implementations, the second interface may refer to an interface between the processing system of the chip or modem and a receiver, such that the device 1700 may obtain information or signal inputs, and the information may be passed to the processing system. A person having ordinary skill in the art will readily recognize that the first interface also may obtain information or signal inputs, and the second interface also may output information or signal outputs.

The reception component 1702 is capable of, configured to, or operable to receive, from an audio stream encoder, an audio stream. The reception component 1702 is capable of, configured to, or operable to receive, from the audio stream encoder, latency control signaling to adjust latency for the audio stream, wherein the latency is adjusted based at least in part on a time modification of audio in the audio stream.

FIG. 18 is a block diagram of an example wireless communication device 1800 that supports adjusting latency in audio streams according to some aspects of the present disclosure. In some examples, the wireless communication device 1800 is configured or operable to perform the process 1400 described with reference to FIG. 14 and/or process 1600 described with reference to FIG. 16. In various examples, the wireless communication device 1800 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 1800 can be a device for use in a STA, such as STA 104 described with reference to FIG. 1. In some other examples, the wireless communication device 1800 can be a STA that includes such a chip, SoC, chipset, package or device as well as multiple antennas. The wireless communication device 1800 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1800 also includes or can be coupled with an application processor which may be further coupled with another memory. In some examples, the wireless communication device 1800 further includes a user interface (UI) (such as a touchscreen or keypad) and a display, which may be integrated with the UI to form a touchscreen display. In some examples, the wireless communication device 1800 may further include one or more sensors such as, for example, one or more inertial sensors, accelerometers, temperature sensors, pressure sensors, or altitude sensors.

The wireless communication device 1800 includes a reception component 1802 and a transmission component 1804. Portions of one or more of the components 1802 and 1804 may be implemented at least in part in hardware or firmware. For example, the reception component 1802 and/or the transmission component 1804 may be implemented at least in part by a modem. In some examples, at least some of the components 1802 and 1804 are implemented at least in part by a processor and as software stored in a memory. For example, portions of one or more of the components 1802 and 1804 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1800). For example, a processing system of the device 1800 may refer to a system including the various other components or subcomponents of the device 1800, such as the processor, or a transceiver, or a communications manager, or other components or combinations of components of the device 1800. The processing system of the device 1800 may interface with other components of the device 1800, and may process information received from other components (such as inputs or signals) or output information to other components. For example, a chip or modem of the device 1800 may include a processing system, a first interface to output information and a second interface to obtain information. In some implementations, the first interface may refer to an interface between the processing system of the chip or modem and a transmitter, such that the device 1800 may transmit information output from the chip or modem. In some implementations, the second interface may refer to an interface between the processing system of the chip or modem and a receiver, such that the device 1800 may obtain information or signal inputs, and the information may be passed to the processing system. A person having ordinary skill in the art will readily recognize that the first interface also may obtain information or signal inputs, and the second interface also may output information or signal outputs.

The transmission component 1804 is capable of, configured to, or operable to transmit, to an audio stream decoder, an audio stream. The transmission component 1804 is capable of, configured to, or operable to transmit, to the audio stream decoder, latency control signaling to adjust latency for the audio stream, wherein the latency is adjusted based at least in part on a time modification of audio in the audio stream.

The following provides an overview of some Aspects of the present disclosure:

Aspect 1: A method performed by an audio device, comprising: receiving, from an audio stream encoder, an audio stream; receiving, from the audio stream encoder and prior to a switching event, latency control signaling to maintain synchronization between different audio channels associated with the audio device and to adjust latency for the audio stream using a combination of multiple time modification algorithms; and adjusting, based at least in part on the latency control signaling and prior to the switching event, the latency using the combination of multiple time modification algorithms.

Aspect 2: The method of Aspect 1, further comprising: applying a time modification to stretch audio in the audio stream, wherein the stretched audio is associated with added latency; or applying a time modification to contract the audio in the audio stream, wherein the contracted audio is associated with reduced latency.

Aspect 3: The method of any of Aspects 1-2, further comprising: adjusting the latency using a combination of a fixed rate overlap add (FROLA) time modification algorithm and a waveform similarity overlap add (WSOLA) time modification algorithm.

Aspect 4: The method of Aspect 3, further comprising: building a buffer of un-played audio using the FROLA time modification algorithm; and selecting, from the buffer of un-played audio, a section of audio in the audio stream to repeat using the WSOLA time modification algorithm.

Aspect 5: The method of Aspect 3, wherein a switch between the FROLA time modification algorithm and the WSOLA time modification algorithm is associated with a latency adjustment.

Aspect 6: The method of any of Aspects 1-5, wherein the latency control signaling includes an indication of one or more timestamps at which a time modification is to be applied to the audio stream, and the latency control signaling is to control and synchronize the time modification at the audio device.

Aspect 7: The method of any of Aspects 1-6, wherein the latency control signaling includes one or more latency control words, and further comprising: performing a packet loss concealment for packet loss and time correction based at least in part on the one or more latency control words, wherein the time correction is achieved using timestamps after the packet loss concealment.

Aspect 8: The method of any of Aspects 1-7, wherein the audio stream encoder is associated with latency control logic and time synchronization, and the audio device is associated with multiple time modification algorithms.

Aspect 9: The method of any of Aspects 1-8, wherein the switching event is a switch of the audio device between access points and the latency is adjusted prior to the switch between access points.

Aspect 10: The method of any of Aspects 1-9, wherein the switching event is the audio device moving from a first latency environment, or connection, or context to a second latency environment, connection, or context.

Aspect 11: The method of any of Aspects 1-10, wherein the audio device is associated with an extended personal area network (XPAN), and the audio device comprises a pair of earbuds.

Aspect 12: A method performed by a mobile station (STA), comprising: transmitting, to an audio stream decoder and prior to a switching event, an audio stream; and transmitting, to the audio stream decoder, latency control signaling to maintain synchronization between different audio channels associated with the audio stream decoder and to adjust latency for the audio stream using a combination of multiple time modification algorithms.

Aspect 13: The method of Aspect 12, wherein: a time modification is associated with a stretching of the audio in the audio stream, and the stretched audio is associated with added latency; or a time modification is associated with a contraction of the audio in the audio stream, and the contracted audio is associated with reduced latency.

Aspect 14: The method of any of Aspects 12-13, wherein the latency is adjusted based at least in part on a combination of a fixed rate overlap add (FROLA) time modification algorithm and a waveform similarity overlap add (WSOLA) time modification algorithm.

Aspect 15: The method of any of Aspects 12-14, wherein a buffer of un- played audio is built using the FROLA time modification algorithm, and a section of audio in the audio stream is selected, from the buffer of un-played audio, to repeat using the WSOLA time modification algorithm.

Aspect 16: The method of any of Aspects 12-15, wherein a switch between the FROLA time modification algorithm and the WSOLA time modification algorithm is associated with a latency adjustment.

Aspect 17: The method of any of Aspects 12-16, further comprising: calculating one or more timestamps at which a time modification is to be applied to the audio stream, wherein the latency control signaling is to control and synchronize the time modification at the STA, and the one or more timestamps are indicated in the latency control signaling.

Aspect 18: The method of any of Aspects 12-17, wherein the latency control signaling includes one or more latency control words, and a packet loss concealment for packet loss and time correction is based at least in part on the one or more latency control words.

Aspect 19: The method of any of Aspects 12-18, wherein the STA is associated with latency control logic and time synchronization.

Aspect 20: The method of any of Aspects 12-19, wherein the switching event is a switch of the STA between access points and the latency is adjusted prior to the switch between access points to avoid an interruption in the audio stream during the switch between the access points, and the latency is adjusted without a pitch change in the audio stream.

Aspect 21: The method of any of Aspects 12-20, wherein the switching event is the STA moving from a first latency environment, or connection, or context to a second latency environment, connection, or context.

Aspect 22: The method of any of Aspects 12-21, wherein the STA is associated with an extended personal area network (XPAN).

Aspect 23: The method of any of Aspects 12-22, wherein the audio stream decoder is associated with a pair of earbuds.

Aspect 24: A method performed by an audio device, comprising: receiving, from an audio stream encoder, an audio stream; receiving, from the audio stream encoder, latency control signaling to adjust latency for the audio stream using a combination of multiple time modification algorithms; and adjusting, based at least in part on the latency control signaling, the latency using the combination of multiple time modification algorithms.

Aspect 25: The method of Aspect 24, further comprising: maintaining synchronization between different audio channels associated with the audio device based at least in part on the latency control signaling, wherein the different audio channels include a first audio channel and a second audio channel.

Aspect 26: The method of any of Aspects 24-25, wherein the latency is adjusted prior to a switching event, and wherein the switching event is associated with a switch of the audio device between access points (APs).

Aspect 27: The method of any of Aspects 24-26, wherein the latency is adjusted prior to a switching event, and wherein the switching event is associated with the audio device moving from a first latency environment, a first connection, or a first context to a second latency environment, a second connection, or a second context.

Aspect 28: A method performed by a mobile station (STA), comprising: detecting a switching event to be associated with the STA; transmitting, to an audio stream decoder and prior to the switching event, an audio stream; and transmitting, to the audio stream decoder, latency control signaling to adjust latency for the audio stream using a combination of multiple time modification algorithms.

Aspect 29: The method of Aspect 28, wherein the switching event is associated with a switch of the STA between access points (APs) and the latency is adjusted prior to the switch between the APs to avoid an interruption in the audio stream during the switch between the APs; the latency is adjusted without a pitch change in the audio stream; or the switching event is associated with the STA moving from a first latency environment, or connection, or context to a second latency environment, connection, or context.

Aspect 30: An apparatus at a device, the apparatus comprising one or more processors; one or more memories coupled with the one or more processors; and instructions stored in the one or more memories and executable by the one or more processors to cause the apparatus to perform the method of one or more of Aspects 1-29.

Aspect 31: An apparatus at a device, the apparatus comprising one or more memories and one or more processors coupled to the one or more memories, the one or more processors configured to cause the device to perform the method of one or more of Aspects 1-29.

Aspect 32: An apparatus, the apparatus comprising at least one means for performing the method of one or more of Aspects 1-29.

Aspect 33: A non-transitory computer-readable medium storing code, the code comprising instructions executable by one or more processors to perform the method of one or more of Aspects 1-29.

Aspect 34: A non-transitory computer-readable medium storing a set of instructions, the set of instructions comprising one or more instructions that, when executed by one or more processors of a device, cause the device to perform the method of one or more of Aspects 1-29.

Aspect 35: A device, the device comprising a processing system that includes one or more processors and one or more memories coupled with the one or more processors, the processing system configured to cause the device to perform the method of one or more of Aspects 1-29.

Aspect 36: An apparatus at a device, the apparatus comprising one or more memories and one or more processors coupled to the one or more memories, the one or more processors individually or collectively configured to cause the device to perform the method of one or more of Aspects 1-29.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus at an audio device, comprising:
one or more memories; and
one or more processors, coupled to the one or more memories, configured to cause the audio device to:
receive, from an audio stream encoder, an audio stream;
receive, from the audio stream encoder, latency control signaling to adjust latency for the audio stream using a combination of multiple time modification algorithms; and
adjust, based at least in part on the latency control signaling, the latency using the combination of multiple time modification algorithms.

2. The apparatus of claim 1, wherein the one or more processors, to adjust the latency, are configured to cause the audio device to:
apply a time modification to stretch audio in the audio stream, wherein the stretched audio is associated with added latency; or
apply a time modification to contract the audio in the audio stream, wherein the contracted audio is associated with reduced latency.

3. The apparatus of claim 1, wherein the one or more processors, to adjust the latency using the combination of multiple time modification algorithms, are configured to cause the audio device to:
adjust the latency using a combination of a fixed rate overlap add (FROLA) time modification algorithm and a waveform similarity overlap add (WSOLA) time modification algorithm.

4. The apparatus of claim 3, wherein the one or more processors are configured to cause the audio device to:
build a buffer of un-played audio using the FROLA time modification algorithm; and
select, from the buffer of un-played audio, a section of audio in the audio stream to repeat using the WSOLA time modification algorithm.

5. The apparatus of claim 3, wherein a switch between the FROLA time modification algorithm and the WSOLA time modification algorithm is associated with a latency adjustment.

6. The apparatus of claim 1, wherein the one or more processors are configured to cause the audio device to:
maintain synchronization between different audio channels associated with the audio device based at least in part on the latency control signaling, wherein the different audio channels include a first audio channel and a second audio channel.

7. The apparatus of claim 1, wherein the latency control signaling includes an indication of one or more timestamps at which a time modification is to be applied to the audio stream, and the latency control signaling is to control and synchronize the time modification at the audio device.

8. The apparatus of claim 1, wherein the latency control signaling includes one or more latency control words, and the one or more processors are configured to cause the audio device to:
perform a packet loss concealment for packet loss and time correction based at least in part on the one or more latency control words, wherein the time correction is achieved using timestamps after the packet loss concealment.

9. The apparatus of claim 1, wherein the latency is adjusted prior to a switching event, and wherein the switching event is associated with a switch of the audio device between access points (APs).

10. The apparatus of claim 1, wherein the latency is adjusted prior to a switching event, and wherein the switching event is associated with the audio device moving from a first latency environment, a first connection, or a first context to a second latency environment, a second connection, or a second context.

11. The apparatus of claim 1, wherein the audio device is associated with an extended personal area network (XPAN).

12. The apparatus of claim 1, wherein the audio device comprises a pair of earbuds.

13. An apparatus at a mobile station (STA), comprising:
one or more memories; and
one or more processors, coupled to the one or more memories, configured to cause the STA to:
detect a switching event to be associated with the STA;
transmit, to an audio stream decoder and prior to the switching event, an audio stream; and
transmit, to the audio stream decoder, latency control signaling to adjust latency for the audio stream using a combination of multiple time modification algorithms.

14. The apparatus of claim 13, wherein:
a time modification is associated with a stretching of the audio in the audio stream, and the stretched audio is associated with added latency; or
a time modification is associated with a contraction of the audio in the audio stream, and the contracted audio is associated with reduced latency.

15. The apparatus of claim 13, wherein the latency is adjusted based at least in part on a combination of a fixed rate overlap add (FROLA) time modification algorithm and a waveform similarity overlap add (WSOLA) time modification algorithm.

16. The apparatus of claim 15, wherein:
a buffer of un-played audio is built using the FROLA time modification algorithm;
a section of audio in the audio stream is selected, from the buffer of un-played audio, to repeat using the WSOLA time modification algorithm; or
a switch between the FROLA time modification algorithm and the WSOLA time modification algorithm is associated with a latency adjustment.

17. The apparatus of claim 13, wherein the one or more processors are configured to cause the STA to:
calculate one or more timestamps at which a time modification is to be applied to the audio stream, wherein the latency control signaling is to control and synchronize the time modification at the STA, and the one or more timestamps are indicated in the latency control signaling.

18. The apparatus of claim 13, wherein the latency control signaling includes one or more latency control words, and a packet loss concealment for packet loss and time correction is based at least in part on the one or more latency control words.

19. The apparatus of claim 13, wherein:
the switching event is associated with a switch of the STA between access points (APs) and the latency is adjusted prior to the switch between the APs to avoid an interruption in the audio stream during the switch between the APs;
the latency is adjusted without a pitch change in the audio stream; or
the switching event is associated with the STA moving from a first latency environment, or connection, or context to a second latency environment, connection, or context.

20. A method performed at an audio device, comprising:
receiving, from an audio stream encoder, an audio stream;
receiving, from the audio stream encoder, latency control signaling to adjust latency for the audio stream using a combination of multiple time modification algorithms; and
adjusting, based at least in part on the latency control signaling, the latency using the combination of multiple time modification algorithms.
